(19) United States
(12) Patent Application Publication
(10) Pub. No.: US 2014/0188656 A1
(43) Pub. Date: Jul. 3, 2014

(54) DETERMINING COST OPTIMIZATION BASED ON CONSTRAINTS ON SKI-RENTAL PROBLEMS

(71) Applicants: Krishna P. Puttaswamy Naga, San Jose, CA (US); Murali Kodialam, Marlboro, NJ (US); Ali Khanafer, Champaign, IL (US)

(72) Inventors: Krishna P. Puttaswamy Naga, San Jose, CA (US); Murali Kodialam, Marlboro, NJ (US); Ali Khanafer, Champaign, IL (US)

(21) Appl. No.: 13/727,852

(22) Filed: Dec. 27, 2012

(51) Int. Cl. G06Q 30/06

(52) U.S. Cl. CPC G06Q 30/0631
USPC 705/26.7

(57) ABSTRACT

A constrained ski-rental problem is defined. In the constrained ski-rental problem, a determination as to whether a first action having a first cost associated therewith or a second action having a second cost associated therewith is more cost effective is performed based on moment information associated with events related to the first action or the second action. The moment information may include a moment of the occurrences distribution of events related to the first and second actions. The moment information may include a moment of a number of occurrences of events related to the first and second actions, a moment of the inter-event times of occurrences of events related to the first and second actions, or the like. The moment information may include a first moment, a second moment, or the like.

### TECHNICAL FIELD

The disclosure relates generally to ski-rental problems and, more specifically but not exclusively, to determining cost optimization based on ski-rental problems.

### BACKGROUND

In general, a ski-rental problem captures the trade-off between buying and renting a product or service when the time period for which the product or service is going to be used is not known in advance. For example, a person may be interested in determining whether to buy a ski at a cost of $B or to rent it at a cost of $1 per day. Clearly, if the person skis for less than B days, the person is better off renting the skis than buying the skis. On the other hand, if the person skis for more than B days, the person is better off buying the skis at the outset than renting the skis. The challenge typically stems from the fact that the person typically does not know how many days he or she will ski. Additionally, similar problems may be posed or encountered in various other contexts.

### SUMMARY OF EMBODIMENTS

Various deficiencies in the prior art may be addressed by embodiments of a constrained ski-rental problem.

In one embodiment, an apparatus includes a processor and a memory communicatively connected to the processor, where the processor is configured to determine whether a first action having a first cost associated therewith or a second action having a second cost associated therewith is more cost effective based on moment information for events associated with the first action and the second action.

In one embodiment, a computer-readable storage medium stores instructions which, when executed by a computer, cause the computer to perform a method that includes determining whether a first action having a first cost associated therewith or a second action having a second cost associated therewith is more cost effective based on moment information for events associated with the first action and the second action.

In one embodiment, a method includes using a processor for determining whether a first action having a first cost associated therewith or a second action having a second cost associated therewith is more cost effective based on moment information for events associated with the first action and the second action.

### BRIEF DESCRIPTION OF THE DRAWINGS

The teachings herein can be readily understood by considering the following detailed description in conjunction with the accompanying drawings, in which:

FIG. 1 depicts a high-level block diagram of a computer suitable for use in performing one or more of a DET process, a PROB process, a μ-PROB process, and a σ-PROB process;

FIG. 2 depicts probability distributions of the PROB, μ-PROB, and σ-PROB processes;

FIG. 3 depicts exemplary CR performances for the DET, PROB, μ-PROB, and σ-PROB processes;

FIG. 4 depicts exemplary worst-case expected CR performances for the DET, PROB, μ-PROB, and σ-PROB processes;

FIGS. 5A, 5B, and 5C depict exemplary expected CR performances for the μ-PROB process using uniform, exponential, and log-normal distributions;

FIGS. 6A and 6B depict exemplary cost performances for the DET, PROB, and μ-PROB processes using fixed and exponential arrival distributions in an exemplary cloud-based file system;

FIG. 7 depicts one embodiment of a method for using a constrained ski-rental problem to perform a decision between two actions having two costs associated therewith;

FIG. 8 depicts one embodiment of a method for determining which of a plurality of ski-rental problems to apply when performing a decision between two actions having two costs associated therewith; and

FIG. 9 depicts a high-level block diagram of a computer suitable for use in performing functions described herein.

To facilitate understanding, identical reference numerals have been used, where possible, to designate identical elements that are common to the figures.

### DETAILED DESCRIPTION OF EMBODIMENTS

In at least some embodiments, a constrained ski-rental problem is defined. In at least some embodiments of the constrained ski-rental problem, a decision as to whether to perform a first action having a first cost associated therewith or a second action having a second cost associated therewith may be made based on moment information associated with events related to the first action and the second action. The moment information may include a moment of the occurrences distribution of events related to the first and second actions. The moment information may include a moment of a number of occurrences of events related to the first and second actions, a moment of the inter-event times of occurrences of events related to the first and second actions, or the like. The moment information may include a first moment, a second moment, or the like. For example, for a typical scenario of a skier faced with a decision as to whether to rent skis or buy skis, the decision as to whether to rent skis or buy skis may be made based on moment information related to the number of ski days in the ski season. Various other applications of the constrained ski-rental problem are described herein.

In at least some embodiments, one or more embodiments of the constrained ski-rental problem may be used in conjunction with one or more embodiments of unconstrained ski-rental problems (e.g., a deterministic ski-rental problem, a probabilistic ski-rental problem, or the like). In at least some embodiments, different embodiments of the constrained or unconstrained ski-rental problems may be used under different conditions, which may be determined based on moment information associated with events related to the two actions to be determined. For example, one range of values of a first moment related to events may be indicative that use of one of the embodiments of the constrained ski-rental problem is preferred over other embodiments of the ski-rental problem, while another range of values of a first moment related to events may be indicative that use of one of the embodiments of the unconstrained ski-rental problem is preferred over other embodiments of the ski-rental problem. For example, one range of values of a second moment related to events may be indicative that use of one of the embodiments of the unconstrained ski-rental problem is preferred over other embodiments of the ski-rental problem, while another range of values of a second moment related to events may be indicative that use of one of the embodiments of the constrained ski-rental problem is preferred over other embodiments of the ski-rental problem.

In at least some embodiments, one or more embodiments of the constrained or unconstrained ski-rental problems may be implemented as one or more processes. In at least some embodiments, the performance of such processes supporting embodiments of the constrained ski-rental problem or embodiments of the unconstrained ski-rental problem may be measured using competitive ratios (CRs), where the competitive ratio of a process is the ratio between the cost incurred when an online version of the process (e.g., running in real or near-real time without knowledge of the future) is used and the cost incurred when an offline version of the process (e.g., run offline such that there is knowledge of the future from the perspective of the events being processed) is used. In at least some embodiments, the use of moment information in constrained ski-rental problems leads to achievement of improved (or even optimum) worst-case expected CR performance and may yield a new class of randomized processes that provide arrivals-distribution-free performance guarantees.

As described herein, various embodiments of the constrained ski-rental problem or various embodiments of the unconstrained ski-rental problem may be used in various applications, such as for determining whether to rent or buy a product or service, determining whether to store a data block in disk or in cache, determining how to handle storage of data in a computer having multiple types of storage modules (e.g., storing data in disk or in RAM), determining how to handle query requests for a given query in a cloud-based system (e.g., recomputing the query result in response to each query request or storing the query result in cache and sourcing the query result from the cache in response to each query request), or the like. The use of various embodiments of the constrained ski-rental problem or various embodiments of the unconstrained ski-rental problem for these and other applications may be better understood by first considering general descriptions of a computer suitable for use in implementing various embodiments of the ski-rental problem and general analysis of various embodiments of the ski-rental problem.

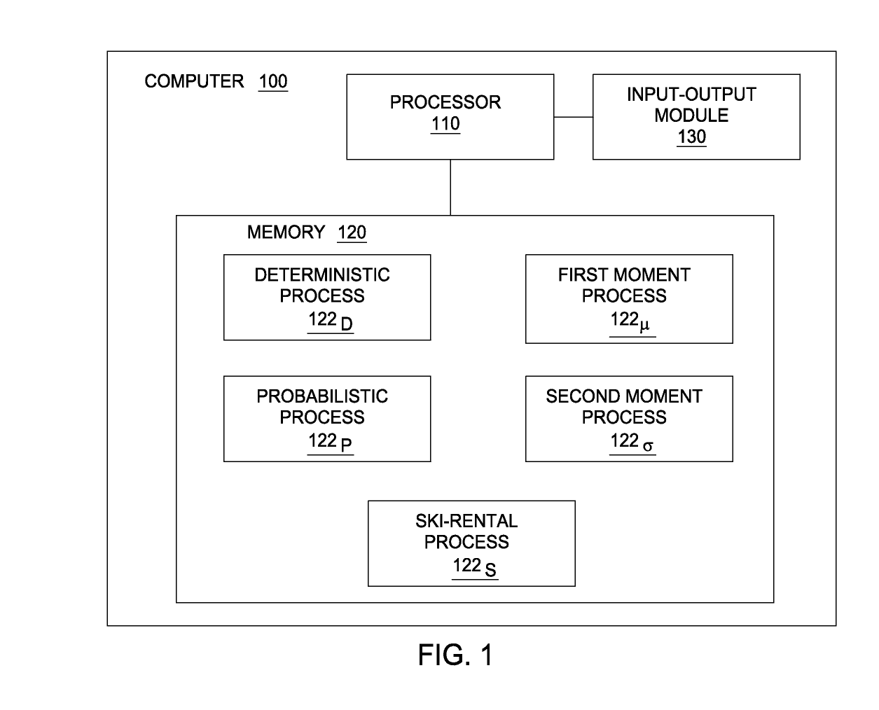

FIG. 1 depicts a high-level block diagram of a computer suitable for use in performing one or more of a DET process, a PROB process, a μ-PROB process, and a σ-PROB process.

As depicted in FIG. 1, computer 100 includes a processor 110, a memory 120, and an input-output (I/O) module 130. The processor 110 may be any type of processor suitable to perform functions depicted and described herein. The memory 120 is communicatively connected to processor 110 and may be implemented using any suitable type(s) of memory (e.g., random access memory (RAM), read only memory (ROM), and the like). The I/O module 130 is communicatively connected to processor 110 and may include any suitable type(s) of I/O elements.

The memory 120 stores one or more processes 122 which may be executed by the processor 110. The processes 122 are configured to provide various embodiments of ski-rental problems. The processes 122 may include one or more unconstrained ski-rental problems, such as one or more of a deterministic process 122_{D} (embodiments of which also may be referred to herein as a DET scheme of DET process 122_{D}), a probabilistic process 122_{P} (embodiments of which also may be referred to herein as a PROB scheme or PROB process 122_{P}), or the like. The processes 122 may include one or more processes configured to support constrained ski-rental problems, such as one or more of a first moment process 122_{μ} (embodiments of which also may be referred to herein as a μ-PROB scheme or μ-PROB process 122_{μ}), and a second moment process 122_{σ} (embodiments of which also may be referred to herein as a σ-PROB scheme or σ-PROB process 122_{σ}). The processes 122 also may include a ski-rental process 122_{S} configured to call one or more of the other processes 122 under various conditions (e.g., based on moment information as described herein). It will be appreciated that the various processes 122 may be used for various applications (e.g., to determine whether to rent or buy a product or service, determine whether to store a data block in disk or in cache, determine how to handle storage of data in a computer having multiple types of storage modules, determine how to handle query requests for a given query in a cloud-based system, or the like). Specific applications of the processes 122 are described in additional detail following generic descriptions of the processes 122, which may be better understood by first considering the ski-rental problem.

In general, a ski-rental problem captures the trade-off between buying and renting a product or service when the time period for which the product or service is going to be used is not known in advance. In the standard ski-rental problem, a user (designer) is interested in determining whether to buy a ski at a cost of $B or to rent it at a cost of $1 per day. Clearly, if the user skis for less than B days, the user is better off renting the skis than buying the skis. On the other hand, if the user skis for more than B days, the user is better off buying the skis at the outset than renting the skis. The challenge stems from the fact that the user does not have advance knowledge of how many days the user is going to ski.

An equivalent problem in a cloud environment (e.g., in which it may be desired to optimize cloud costs) is a determination, for a given query to the cloud environment, as to whether to recompute the result of a query each time that the query is received or to store the result of the query such that the result of the query may be served from memory each time that the query is received. Similar to the ski-rental problem discussed above, let the cost of storing the result of the query be $1 per unit time and let the cost of recomputing the result of the query be $B. Similar to the ski-rental problem, if the next query arrives before B time units then it is better to store the result of the query and serve the result of the query when the next query arrives, whereas if the next query arrives after B time units then it is better to recompute the result of the query when the query arrives. Again, the challenge stems from the fact that the system does not have advance knowledge of how many time units will pass before the next query arrives. It will be appreciated that a similar analogy can be made for the problem of determining whether to store a data block in disk or in cache, depending on the number of time units between requests associated with the data block. It will be further appreciated that other similar analogies may be made.

In at least some embodiments, the uncertainty of the ski-rental problem and various equivalent or similar problems (e.g., responding to queries in a cloud environment, moving data blocks of a file system between disk and cache, or the like) may be addressed using one or more online processes adapted to determine the optimal choice for the user at every time instant.

In at least some embodiments, a deterministic scheme (embodiments of which may be referred to herein as DET or the DET process 122_{D}) may be used to solve the ski-rental problem, where the deterministic scheme specifies that the designer should rent the skis up until the B^{th} day at which point the designer should buy the skis. The CR achieved by the deterministic scheme is 1 for arrivals occurring before time B and 2 for arrivals occurring after time B. Hence, the DET scheme is 2-competitive, since it yields a worst-case CR of 2. In other words, the best achievable performance of the deterministic scheme DET is 1 and the worst achievable performance of the deterministic scheme DET is 2.

In at least some embodiments, an optimal randomized probabilistic scheme (embodiments of which may be referred to herein as PROB or the PROB process 122_{P}) may be used to solve the ski-rental problem, where the probabilistic scheme specifies that the user switches from renting the skis to buying the skis at a chosen random time. The CR achieved by the probabilistic scheme PROB is

$$\frac{e}{e - 1}$$

regardless of the arrival time. In other words, the best and worst achievable performance of the probabilistic scheme is

$$\frac{e}{e - 1} .$$

In at least some embodiments, the ski-rental problem may be solved based on additional information associated with the strategy of the adversary. The additional information may include the first moment μ of the strategy of the adversary (e.g., mean) or the second moment a of the strategy of the adversary (e.g., variance). In other words, an assumption may be made that the designer possesses information about the strategy of the adversary. For example, when determining whether to rent or buy skis, information indicative of the average number of ski days, variance of number of ski days, or the like (e.g., higher order moments) may be used to help the designer decide whether to rent or buy the skis. Similarly, for example, when determining whether to store a data block in disk or cache, the average inter-arrival times of the data block, variance of the inter-arrival times of the data block, or the like (e.g., higher order moments) may be used to help the designer decide whether to store the data block in disk or in cache (and, optionally, the length of time for which the data block is stored in the cache before being evicted from the cache such that the data block is stored only in the disk). In at least some embodiments, a scheme or policy may be used to solve the ski-rental problem under a constraint on the first moment of the strategy of the adversary (embodiments of which may be referred to herein as μ-PROB). In at least some embodiments, a scheme or policy may be used to solve the ski-rental problem under a constraint on the second moment of the strategy of the adversary (embodiments of which may be referred to herein as σ-PROB). It is noted that, in at least some embodiments, one or more of the schemes or policies may be independent (or nearly independent) of the first and second moments of the strategy of the adversary and even may be used when the additional information discussed above (e.g., number of ski days, inter-arrival times between requests for a data block, and the like) is not known. The embodiments of μ-PROB and σ-PROB may be referred to herein as schemes or policies which solve a modified version of the ski-rental problem referred to herein as a constrained ski-rental problem. It will be shown that performance of the solutions to the constrained ski-rental problem (e.g., the μ-PROB process 122_{μ} and the σ-PROB process 122_{σ}) is more robust than performance of the solutions to the standard ski-rental problem (e.g., the DET and PROB processes).

In general, in the constrained ski-rental problem, the rental price is $1 (which, it will be appreciated, is merely selected for simplicity) and the buying price is $B. Let x be the time at which the designer decides to buy the ski, and let p(x) be the probability distribution over x. Also, let y be the arrival time (e.g., the number of snow days) chosen by the adversary with q(y) being the probability distribution over y. The designer (adversary) is interested in selecting p(x) (q(y)) in such a way that would minimize (maximize) the expected CR. The cost incurred by the designer is a function of the number of snow days, which is controlled by the adversary and is not known by the designer, and the randomized strategy applied by the designer. The strategy of the designer is an “online” process as the designer acts without knowledge of the number of snow days. The expected cost incurred by the designer is denoted by C(p(x),y). Let OPT(y) denote the cost incurred by an optimal “offline” algorithm. Given the above definitions, the CR may be expressed as:

$$c = \frac{C ( p ( x ) , y )}{OPT ( y )} .$$

The possible values for OPT(y) may be specified as follows. If y≦B, the strategy that minimizes the overall cost is renting the skis for the period [0,y]. On the other hand, if y>B, then it is optimal to buy the skis. Formally, the possible values for OPT(y) may be expressed as:

$$OPT ( y ) = \{ \begin{matrix}y , & if y \leq B , \\ B , & otherwise .\end{matrix} \qquad Eq . ( 1 )$$

The value of C(p(x),y) depends on when the designer decides to buy the skis. If x≦y, the designer will have to pay $x for the rental period in addition to the buying price of $B. However, if y<x, the designer will not have to buy the skis and will pay $y in rental fees. Hence, for y≦B, the expected cost can be written as

C(p(x),y)=∫₀^{y}(x+B)p(x)dx+∫_{y}^{B}yp(x)dx. Eq. (2)

The case when y>B is discussed below.

Given the conflicting objectives of the designer and the adversary, game theory may be used to derive the optimal strategies for both the designer and the adversary. While the problem may be formulated as a continuous-kernel zero-sum game, a matrix zero-sum game is formulated first. The matrix zero-sum game formulation and the continuous-kernel zero-sum game formulation may aid in providing an understanding of the decision processes of the designer and the adversary.

As noted above, the problem may be formulated as a matrix zero-sum game. Assume that the (pure) strategy space for both the designer and the adversary is the countably infinite set {1, 2, 3, . . . }. Let [Aᵢⱼ]=A be the matrix of the zero-sum game, with the designer being the row player and the adversary being the column player. The matrix may be represented using the following table:

TABLE 1

| B | B/2 | B/3 | . . . | B/(B − 1) | 1 | 1 | 1 | . . . |
|---|---|---|---|---|---|---|---|---|
| 1 | (B + 1)/2 | (B + 1)/3 | . . . | (B + 1)/(B − 1) | (B + 1)/B | (B + 1)/B | (B + 1)/B | . . . |
| 1 | 1 | (B + 2)/3 | . . . | (B + 2)/(B − 1) | (B + 2)/B | (B + 2)/B | (B + 2)/B | . . . |
| . | . | . | . | . | . | . | . | . |
| . | . | . | . | . | . | . | . | . |
| . | . | . | . | . | . | . | . | . |
| 1 | 1 | 1 | . . . | 1 | 1 | (2B − 1 )/B | (2B − 1 )/B | . . . |
| 1 | 1 | 1 | . . . | 1 | 1 | 2 | 2 | . . . |
| 1 | 1 | 1 | . . . | 1 | 1 | (B + 1)/B | (2B + 1)/B | . . . |
| 1 | 1 | 1 | . . . | 1 | 1 | (B + 1)/B | (B + 2)/B | . . . |
| 1 | 1 | 1 | . . . | 1 | 1 | (B + 1)/B | (B + 2)/B | . . . |
| . | . | . | | . | . | . | . | . |
| . | . | . | | . | . | . | . | . |
| . | . | . | | . | . | . | . | . |

In the matrix depicted in Table 1, the i-th row corresponds to the case where the designer chooses to rent the ski for i−1 days and to buy the ski on the i-th day, and the j-th column corresponds to the adversary choosing the number of snow days to be j. Hence, the (i,j)-th element of A is the CR corresponding to the designer choosing i and the adversary choosing j.

By studying the matrix game A, it will be appreciated that the (B+1)-th column dominates the B-th column, i.e., A_{i(B+1)}≧A_{iB} with A_{i(B+1)}>A_{iB} for at least one i. In fact, the (B+j)-th column dominates the (B+j−1)-th column for j≧1. Thus, the dominated column may be removed from the matrix, and the resulting matrix will be strategically equivalent to A. After removing the dominated columns, it may be seen that the B-th row dominates the (B+i)-th rows, i≧1, i.e., A_{Bj}≦A_{(B+i)j} with A_{Bj}<A_{(B+i)j} for at least one j, i≧1. After removing the dominated rows, the resulting matrix game Ã can be written as:

TABLE 2

| B | B/2 | B/3 | . . . | B/(B − 1) | 1 |
|---|---|---|---|---|---|
| 1 | (B + 1)/2 | (B + 1)/3 | . . . | (B + 1)/(B − 1) | (B + 1)/B |
| 1 | 1 | (B + 2)/3 | . . . | (B + 2)/(B − 1) | (B + 2)/B |
| . | . | . | . | . | . |
| . | . | . | . | . | . |
| . | . | . | . | . | . |
| 1 | 1 | 1 | . . . | 1 | (2B − 1)/B |

In the matrix Ã of Table 2, it is noted that the first B rows in the (B+j)-th, j≧1, columns have the same values. Thus, the adversary will exhibit the same performance regardless of which column the adversary chooses, as long as j>B. It also may be noted that, by strict dominance, it is possible to convert an infinite game into a finite game. Additionally, it is possible to obtain an exact equilibrium for the game without constructing an ε-equilibrium as the performance that the adversary achieves as j→∞ is identical to the performance that the adversary achieves when j=B+k, k≧1, kεN.

As noted above, the problem also may be formulated as a continuous-kernel zero-sum game. It is noted that insights may be obtained from Ã when deriving the strategies of the designer and the adversary in the continuous-time case. In the discrete-time case, the strategy space of the designer reduces to {1, 2, . . . , B}. Thus, in the continuous-time case, the designer needs only to assign probabilities over the interval [0,8]. The strategy space of the designer may then be written as:

P={p(x)≧0,xε[0,B]:∫₀^{B}p(y)dy=1}.

However, the situation is different for the adversary as the strategy space of the adversary in the discrete-time case becomes {1, 2, . . . , B−1, K}, where K>B. Thus, the strategy of the adversary is constructed as a two-part randomized strategy as follows: a probability density over the interval [0,B) and a probability mass at K≧B. The probability mass at K is denoted by q_{K}=q(y=K). As noted above, the strategy of the adversary may be evaluated while considering one or more constraints on the strategy of the adversary.

In at least some embodiments, the strategy of the adversary is evaluated based on an assumption that there is a constraint on the first moment of the strategy of the adversary. This may be expressed as:

∫₀^{B}yq(y)dy+q_{K}·K=μ. Eq. (3)

The strategy space of the adversary in such embodiments is:

Q={q(y)0yε[0,B)∪K, K≧B: ∫₀^{B}q(y)dy+q_{K}=1 and Eq. (3) is satisfied}.

In at least some embodiments, the strategy of the adversary is evaluated based on an assumption that there is a constraint on the first moment of the strategy of the adversary. This may be expressed as:

∫₀^{B}y²q(y)dy+K²q_{K}=σ. Eq. (4)

The zero-sum game played by the designer and the adversary may be formulated as follows. The objective function of the designer is the expected CR denoted J(p,q), and it follows that the objective function of the adversary is −J(p,q). Thus, it is the average, with respect to q(y), of the CR for yε[0,B) and y=K. Since K≧B, and xε[0,B], it may be concluded that the cost incurred by the player will be x+B at K. Thus, using (1) and (2), the expected CR may be written as:

$$\begin{matrix}J ( p , q ) = {E}_{q} [ c ] \\ = {\int }_{0}^{B} \frac{C ( p ( x ) , y )}{y} q ( y ) d y + {q}_{K} \cdot {\int }_{0}^{B} \frac{x + B}{B} p ( x ) d x .\end{matrix}$$

The zero-sum game is denoted by G={P,Q,J}. The solution concept which may be used to study G is a mixed-strategy saddle-point equilibrium, which is defined below. Consider the following definition (denoted as Definition 1): The pair (p*,q*) constitutes a saddle-point equilibrium in mixed-strategies for G if J(p*,q)≦J(p*,q*)≦J(p,q*), for any pεP and qεQ.

By Von Nuemann's minimax theorem, it may be determined that:

$${min}_{p ( x ) ∈ P} {max}_{q ( Y ) ∈ Q} J ( p , q ) = {max}_{Q ( Y ) ∈ P} {min}_{P ( X ) ∈ P} J ( p , q ) . \qquad Eq . ( 5 )$$

This may be used to derive optimal mixed-strategies for both players (namely, the designer and the adversary).

In at least some embodiments, the optimal strategy p*(x) of the designer may be obtained by solving the following problem:

$${min}_{p ( x ) ∈ P} {max}_{q ( Y ) ∈ Q} J ( p , q ) .$$

In at least some embodiments, this problem may be solved by: (1) constructing the dual to the maximization problem (where it is noted that the dual turns out to be a linear program (LP) with two equality constraints), (2) differentiating one of the equality constraints twice to obtain a first-order ODE which can be used, along with the fact that p(x) is a probability distribution function (PDF), to obtain p(x) as a function of the Lagrange multiplier associated with the constraint on q(y), and (3) obtaining, by substituting the obtained PDF into the original equality constraints, an LP in the Lagrange multipliers (which, it is noted) can readily be solved. It is noted that, in step (3), an infinite dimensional optimization problem is converted to a finite scalar optimization problem (as we were originally solving for p(x)).

In at least some embodiments, a modified version of the ski-rental problem, in which the first moment (μ) is constrained, may be formulated and solved. In at least some such embodiments, p*(x) may be derived when the first moment μ is constrained. The derivation of p*(x) when the first moment μ is constrained may be determined by constructing the dual problem. The Lagrangian associated with the maximization problem may be written as:

$$L ( q ( y ) , {λ}_{1} , {λ}_{2} ) = {\int }_{0}^{B} \underbrace{( \frac{C ( p ( x ) , y ) )}{y} - {λ}_{1} - {λ}_{2} y )}_{:= {h}_{1} ( y )} q ( y ) d y + {q}_{K} \cdot \underbrace{( {\int }_{0}^{B} \frac{x + B}{B} p ( x ) d x - {λ}_{1} + {λ}_{2} K )}_{: h 2} + ( {λ}_{1} + {λ}_{2} μ ) .$$

Thus, the dual function g(λ₁,λ₂)=sup_{q(y)εQ}L(q(y),λ₁,λ₂) may be given by:

$$g ( {λ}_{1} , {λ}_{2} ) = \{ \begin{matrix}{λ}_{1} + {λ}_{2} μ , & if {h}_{1} ( y ) = 0 , {h}_{2} = 0 , ∀ y , \\ ∞ , & otherwise .\end{matrix}$$

Hence, after adding the constraints on p(x), the dual becomes:

$$\begin{matrix}{max}_{p ( x ) ∈ P , {λ}_{1} , {λ}_{2}} {λ}_{1} + {λ}_{2} μ & Eq . ( 6 ) \\ s . t . \\ \frac{C ( p ( x ) , y )}{y} = {λ}_{1} + {λ}_{2} y , & Eq . ( 7 ) \\ {\int }_{0}^{B} \frac{x + B}{B} p ( x ) d x = {λ}_{1} + {λ}_{2} K , \\ ∀ y ∈ [ 0 , B ] , {λ}_{1} , {λ}_{2} \geq 0. & Eq . ( 8 )\end{matrix}$$

It is noted that, since Eq. (7) holds for all y, both sides may be differentiated twice with respect to y, and y may be replaced with x to obtain:

$$\frac{d}{d x} P ( x ) = \frac{1}{B} ( p ( x ) + 2 {λ}_{2} ) .$$

This is a first-order ODE with a solution of:

$$p ( x ) = α {e}^{\frac{x}{B}} - 2 {λ}_{2} . \qquad Eq . ( 9 )$$

It is noted that a solution for a may be determined by using the fact that p(x) is a PDF to obtain:

$$α = \frac{1 + 2 {λ}_{2} B}{B ( e - 1 )} .$$

By substituting Eq. (9) into Eq. (7) and Eq. (8), the following equivalent conditions may be obtained:

$$\begin{matrix}( 2 \frac{2 - e}{e - 1} B ) {λ}_{2} + \frac{e}{e - 1} = {λ}_{1} , & Eq . ( 10 ) \\ ( \frac{3 - e}{e - 1} B - K ) {λ}_{2} + \frac{e}{e - 1} = {λ}_{1} . & Eq . ( 11 )\end{matrix}$$

Further, the equality p(x)≧0 is maintained for xε[0,B] or, equivalently:

$$( 1 - \frac{e \frac{x}{B}}{e - 1} ) {λ}_{2} \leq \frac{e \frac{x}{B}}{2 B ( e - 1 )} .$$

It will be appreciated that requiring the PDF to be positive imposes the following constraints on λ₂:

$$\begin{matrix}{λ}_{2} \leq \frac{e \frac{x}{B}}{2 B ( e - 1 - e \frac{x}{B} )} , \\ if \\ 0 \leq x \leq B log ( e - 1 ) , & Eq . ( 12 ) \\ {λ}_{2} > \frac{e \frac{x}{B}}{2 B ( e - 1 - e \frac{x}{B} )} , \\ if \\ B log ( e - 1 ) < x \leq B . & Eq . ( 13 )\end{matrix}$$

It will be appreciated that the right hand side of Eq. (12) is positive and strictly increasing for xε[0,B log(e−1)), whereas the right hand side of Eq. (13) is negative for xε(B log(e−1),B]. Therefore, this gives:

$$0 \leq {λ}_{2} \leq \frac{1}{2 B ( e - 2 )} .$$

Thus, the problem for the designer is equivalent to the following LP:

$${max}_{{λ}_{1} {λ}_{2}} {λ}_{1} + {λ}_{2} μ \\ s . t . \\ ( 2 \frac{2 - e}{e - 1} B ) {λ}_{2} + \frac{e}{e - 1} = {λ}_{1} , \\ ( \frac{3 - e}{e - 1} B - K ) {λ}_{2} + \frac{e}{e - 1} = {λ}_{1} , \\ {λ}_{1} \geq 0 , \\ 0 \leq {λ}_{2} \leq \frac{1}{2 B ( e - 1 )} . \qquad Eq . ( 14 )$$

It will be appreciated, by the fundamental theorem of LPs, that the solutions to this LP form a convex polytope, and that each basic feasible solution (λ₁,λ₂) is a corner point of the polytope (and vice versa). It also will be appreciated that if λ₂>0, then B=K is needed in order to satisfy both Eq. (10) and Eq. (11). Hence, there are two corner points as follows:

$${b}_{1} = ( \frac{e}{e - 1} , 0 )$$

$$and$$

$${b}_{2} = ( 1 , \frac{1}{2 B ( e - 2 )} ) .$$

The corresponding values to these points are:

$$( {λ}_{1} + {λ}_{2} μ {{\vert}_{{b}_{1}} = \frac{e}{e - 1} , ( {λ}_{1} + {λ}_{2} μ ) \vert}_{{b}_{2}} = 1 + \frac{μ}{2 B ( e - 2 )} . \qquad Eq . ( 15 )$$

It will be appreciated that these values are the resulting expected CRs. It will be appreciated that, when λ₂=0, the problem becomes a classical ski-rental problem without a constraint on the mean (where the optimal expected CR under a randomized algorithm for the classical ski-rental problem is

$$\frac{e}{e - 1} ,$$

which is obtained under b₁). By comparing the obtained values at b₁ and b₂, it may be concluded that:

If

$$\frac{μ}{B} \leq 2 \frac{e - 2}{e - 1} ,$$

the optimal PDF is given by:

$${p}^{*} ( x ) = \{ \begin{matrix}\frac{1}{B ( e - 2 )} ( {e}^{\frac{x}{B}} - 1 ) , & 0 \leq x \leq B , \\ 0 , & otherwise .\end{matrix} \qquad Eq . ( 16 )$$

Otherwise, the optimal PDF is given by:

$${p}^{*} ( x ) = \{ \begin{matrix}\frac{1}{B ( e - 1 )} {e}^{\frac{x}{B}} , & 0 \leq x \leq B , \\ 0 , & otherwise .\end{matrix} \qquad Eq . ( 17 )$$

In other words, when the value of the first moment is relatively high (e.g., when

$$μ > 2 \frac{e - 2}{e - 1} B ) ,$$

then knowing the value of the first moment does not provide the designer with additional information and, thus, the optimal randomized strategy is the optimal randomized probabilistic scheme PROB (rather than μ-PROB). It will be appreciated that (a) the value of the first moment μ decides which PDF is optimal and (b) Eq. (16) is independent of the first moment μ.

In at least some embodiments, a modified version of the ski-rental problem, in which the second moment (σ) is constrained, may be formulated and solved. In at least some such embodiments, p*(x) may be derived when the second moment σ is constrained. The derivation of p*(x) when the second moment σ is constrained may be determined using analysis similar to that in which the first moment μ is constrained. The derivation of p*(x) when the second moment σ is constrained may be determined by constructing the dual problem. First, Eq. (3) is replaced with Eq. (4) in the definition of Q. Then, using the steps leading to Eq. (14) for embodiments in which the first moment μ is constrained, the following LP to be solved by the designer may be obtained:

$${max}_{{λ}_{1} {λ}_{2}} {λ}_{1} + {λ}_{2} σ$$

$$s . t . \\ ( 3 \frac{5 - 2 e}{e - 1} {B}^{2} ) {λ}_{2} + \frac{e}{e - 1} = {λ}_{1} , \\ ( \frac{14 - 5 e}{e - 1} {B}^{2} - {K}^{2} ) {λ}_{2} + \frac{e}{e - 1} = {λ}_{1} , \\ {λ}_{1} \geq 0 , \\ 0 \leq {λ}_{2} \leq \frac{1}{3 {B}^{2} ( 2 e - 5 )} .$$

It will be appreciated that, when λ₂>0, B=K may be used in order to satisfy the equality constraints simultaneously. Additionally, the following two corner points may be identified:

$${\tilde{b}}_{1} = ( \frac{e}{e - 1} , 0 ) and {\tilde{b}}_{2} = ( 1 , \frac{1}{3 {B}^{2} ( 2 e - 5 )} ) .$$

The corresponding expected CRs are:

$$( {λ}_{1} + {λ}_{2} μ {\vert}_{{\tilde{b}}_{1}} = \frac{e}{e - 1} , ( {λ}_{1} + {λ}_{2} μ ) {\vert}_{{\tilde{b}}_{2}} = 1 + \frac{μ}{3 {B}^{2} ( 2 e - 5 )} . \qquad Eq . ( 18 )$$

### Thus, if

$${p}^{*} ( x ) = \{ \begin{matrix}\frac{2}{B ( 2 e - 5 )} ( {e}^{\frac{x}{B}} - \frac{x + B}{B} ) , & 0 \leq x \leq B , \\ 0 , & otherwise .\end{matrix} \qquad Eq . ( 19 )$$

the optimal PDF is:

$$\frac{σ}{{B}^{2}} \leq 3 \frac{2 e - 5}{e - 1} ,$$

Otherwise, the optimal solution is the optimal randomized probabilistic scheme PROB given in Eq. (17) (rather than a-PROB). It will be appreciated that the optimal strategy is independent of the additional information possessed by the designer (namely, the second moment σ).

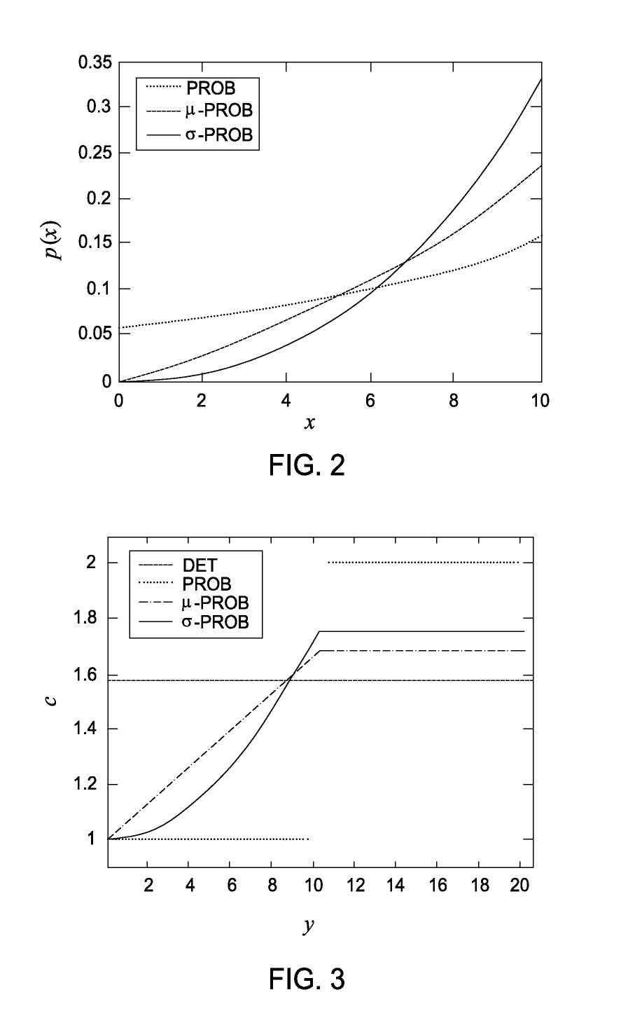

FIG. 2 depicts probability distributions of the PROB process, the μ-PROB process, and the σ-PROB process of FIG. 1. More specifically, FIG. 2 depicts Probability Distribution Functions (PDFs) for the PROB process 122_{P}, μ-PROB process 122_{μ}, and σ-PROB process 122_{σ}. As depicted in FIG. 2, time is measured on the x-axis and probability is measured on the y-axis, thereby illustrating the probability with which the various processes 122 decide to buy (rather than rent) for different values of time. It will be appreciated that the units of time depend on the inputs to the various processes 122, such as one or more of the type of determination to be made (e.g., determining whether to rent or buy a product or service, determining whether to store a data block in disk or in cache, determining how to handle storage of data in a computer having multiple types of storage modules, determining how to handle query requests for a given query in a cloud-based system, or the like), the type of events associated with the determination (e.g., expected uses of a product or service is, accesses to a data block, or the like), the type of moment information to be used (e.g., the number of days a product or service is expected to be used, the inter-event time between use of a product or service, the number of accesses to a data block, the inter-arrival times between requests for a data block, or the like), or the like, as well as various combinations thereof.

The DET process 122_{D}, PROB process 122_{P}, μ-PROB process 122_{μ}, and σ-PROB process 122_{σ} may be compared based on the CR performances of the processes for various arrival values.

FIG. 3 depicts exemplary CR performances for the DET, PROB, μ-PROB, and σ-PROB processes. More specifically, FIG. 3 depicts the CR performances for the DET process 122_{D}, the PROB process 122_{P}, the μ-PROB process 122_{μ}, and the σ-PROB process 122_{σ} for an exemplary embodiment in which B=10. For the proposed processes, the curves were computed using the left hand side of Eq. (7) for y≦B and the left hand side of Eq. (8) for y>B. It will be appreciated that a balance is struck between the CR performance of DET process 122_{D} and PROB process 122_{P}. It also will be appreciated that the σ-PROB process 122_{σ} outperforms the μ-PROB process 122_{μ} for y≦B. It will be appreciated that, although omitted for purposes of clarity, performance may be further improved using constraints on higher moments (e.g., the third moment, the fourth moment, etc), although the improvement may be accompanied by a relatively slight deterioration in performance over the interval y>B.

The CR achieved by the μ-PROB process 122_{μ} and the σ-PROB process 122_{σ} may be compared to the CR achieved by the PROB process 122_{P} for y>B. The comparison may be performed by computing:

$$( {λ}_{1} + {λ}_{2} B ) {\vert}_{{b}_{2}} = \frac{2 e - 3}{2 ( e - 2 )} , ( {λ}_{1} + {λ}_{2} {B}^{2} ) {\vert}_{{\tilde{b}}_{2}} = \frac{6 e - 14}{3 ( 2 e - 5 )} ,$$

which indicates that the difference between the CR achieved by the μ-PROB process 122_{μ} and σ-PROB process 122_{σ} and the CR achieved by the PROB process 122_{P} is:

$$\frac{2 e - 3}{2 ( e - 2 )} - \frac{e}{e - 1} = 0.114 , \frac{6 e - 14}{3 ( 2 e - 5 )} - \frac{e}{e - 1} = 0.182 .$$

This indicates that the μ-PROB process 122_{μ} and the σ-PROB process 122_{σ} exhibit CR performance comperable to the CR performance of the PROB process 122_{P} for y>B.

Additionally, the worst-case expected CRs achieved by the μ-PROB process 122_{μ} and the σ-PROB process 122_{σ} may be determined by averaging over the arrival values. For the PROB process 122_{P}, the expected CR is

$$\frac{e}{e - 1} .$$

In order to compare the PROB process 122_{P}, the μ-PROB process 122_{μ}, and the σ-PROB process 122_{σ} with the DET process 122_{D}, consider the following two lemmas.

Lemma 1: In the first-moment-constrained ski-rental problem, the worst-case expected CR for the DET process 122_{D} is at least

$$1 + \frac{μ}{B}$$

when 0≦μ≦B, and it is at least 2 when μ>B.
Here, in order to find a lower bound on the worst-case CR, it suffices to find a distribution \hat{q}(y) that yields the proclaimed values. More formally, this gives:

$${max}_{q ( y ) ∈ Q} {min}_{p ( x ) ∈ P} J ( p , q ) \geq {min}_{p ( x ) ∈ P} J ( p , \hat{q} ) .$$

Then, consider the following candidate distribution for 0≦μ≦B:

$${q}^{⋒} ( y ) = \{ \begin{matrix}1 - \frac{μ}{B} , & y = 0 \\ \frac{μ}{B} , & y = {B}^{+} , \\ 0 , & otherwise ,\end{matrix}$$

where B⁺=B+ε,ε>0. This distribution satisfies the first moment constraint as ε→0. Then, assuming that the DET process 122_{D} is used, the following computation may be performed:

$${E}_{{q}^{⋒}} = 1 \cdot ( 1 - \frac{μ}{B} ) + 2 \cdot \frac{μ}{B} = 1 + \frac{μ}{B} .$$

Similarly, when μ>B, the following distribution may be used:

$$\hat{q} ( y ) = \{ \begin{matrix}1 , & y = μ , \\ 0 , & otherwise .\end{matrix}$$

Lemma 2: In the second-moment-constrained ski-rental problem, the worst-case expected CR for the DET process 122_{D} is at least

$$1 + \frac{σ}{{B}^{2}}$$

when 0≦σ≦B², and it is at least 2 when σ>B².
The PDF that guarantees a worst-case CR of

$$1 + \frac{σ}{{B}^{2}}$$

when 0≦σ≦B² is:

$$\hat{q} ( y ) = \{ \begin{matrix}1 - \frac{σ}{{B}^{2}} , & y = 0 \\ \frac{σ}{{B}^{2}} , & y = {B}^{+} , \\ 0 , & otherwise .\end{matrix}$$

The PDF that guarantees a worst-case CR of 2 when σ>B² is:

$$\hat{q} ( y ) = \{ \begin{matrix}1 , & y = \sqrt{σ} , \\ 0 , & otherwise .\end{matrix}$$

From Lemmas 1 and 2 and Eq. (15) and Eq. (18), and by comparing the obtained expected CRs for the PROB process 122_{P}, the μ-PROB process 122_{μ}, and the σ-PROB process 122_{σ}, the following conclusions may be drawn:

(a) when

$$0 \leq μ \leq 2 \frac{e - 2}{e - 1} B ( or 0 \leq σ \leq 3 \frac{2 e - 5}{e - 1} {B}^{2} ) ,$$

the μ-PROB process 122_{μ} (or the σ-PROB process 122_{σ}) outperforms the DET process 122_{D} and the PROB process 122_{P}, and

(b) when

$$μ > 2 \frac{e - 2}{e - 1} B ( or σ > 3 \frac{2 e - 5}{e - 1} {B}^{2} ) ,$$

the PROB process 122_{P} outperforms the DET process 122_{D}, because

$$\frac{e}{e - 1} < 1 + \frac{μ}{B} ( or \frac{e}{e - 1} < 1 + \frac{σ}{{B}^{2}} )$$

for these values of μ, and

$$\frac{e}{e - 1} = 1.582 < 2$$

(however, it is note that the optimal solution is obtained from the PROB process 122_{P} over this range, as may be seen from the conditions leading to Eq. (16) and Eq. (17) (or Eq. (19)).

Thus, it will be appreciated that for any value of the first moment μ (or the second moment σ) use of a combination of the DET process 122_{D}, the PROB process 122_{P}, the μ-PROB 122_{μ}, and the σ-PROB process 122_{σ} produces a policy yielding the best worst-case expected CR. FIG. 3 demonstrates an example of this for B=10 (although it will be appreciated that use of B=10 is merely exemplary, and that any suitable value of B may be used). It may be shown that this is the best possible CR by generating an arrival time distribution such that the bound given by the μ-PROB process 122_{μ} is relatively tight. This may be shown by solving the problem of the adversary.

As noted above, the μ-PROB process 122_{μ} and the σ-PROB process 122_{σ} may be better understood by considering the problem of the adversary. Namely, consider a case in which only the first moment of q(y) is constrained (it is noted that the problem of the adversary under a second moment constraint is similar to the problem of the adversary with a constraint on the mean and, thus, is omitted). The adversary attempts to solve the following problem:

$${max}_{q ( y ) ∈ Q} {min}_{p ( x ) ∈ P} J ( p , q ) .$$

The following steps may be used to solve this problem: (1) construct the dual to the minimization problem (where the dual may be shown to be an LP with an equality constraint), (2) obtain a first-order ODE, which can be used to solve for q(y), by differentiating the equality constraint twice, and (3) solve for q_{K} by evaluating the equality constraint at specific values and by using Von Neumann's theorem. It will be appreciated that the constraint on the first moment may be used to obtain a range of possible values for K.

The dual to the minimization problem (e.g., by following steps similar to the steps described above) may be constructed as follows:

$${max}_{q ( y ) ∈ λ} λ \\ s . t . g ( x ) + {q}_{K} \cdot \frac{x + B}{B} = λ , \\ g ( x ) = {\int }_{0}^{x} q ( y ) d y + {\int }_{x}^{B} \frac{x + B}{y} q ( y ) d y , \\ ∀ x ∈ [ 0 , B ] , λ \geq 0. \qquad Eq . ( 21 )$$

The first-order ODE, which can be used to solve for q(y), may be obtained by differentiating the equality constraint (namely, Eq. (22)) twice as follows:

$$\frac{d}{d y} q ( y ) = \frac{B - y}{By} q ( y ) ,$$

whose solution is given by

$$q ( y ) = β y {e}^{- \frac{y}{B}} .$$

Additionally, q*(y) may be fully characterized by solving for β, K, and q_{K}.
Based on the fact that q(y) must integrate to 1-q_{K}, β is obtained as follows:

$$β = \frac{1 - {q}_{K}}{{B}^{2} ( 1 - \frac{2}{e} )} .$$

By invoking Von Neumann's theorem and making use of the fact that the values of Eq. (6) and Eq. (21) must be equal (because they are dual to each other), q_{K} is obtained.

When

$$\frac{μ}{B} > 2 \frac{e - 2}{e - 1} , then {λ}^{*} = \frac{e}{e - 1} .$$

By evaluating Eq. (22) at x=B, q_{K} may be obtained as follows:

$${q}_{K} = \frac{1}{e - 1} .$$

It will be appreciated that, since the mean is large in this case and the designer does not use knowledge of the mean, the adversary can relax the constraint on the mean and K can be chosen freely. When

$$\frac{μ}{B} \leq 2 \frac{e - 2}{e - 1} , {λ}^{*} = 1 + \frac{μ}{2 B ( e - 2 )} ,$$

and, thus:

$${q}_{K} = \frac{μ}{2 B ( e - 2 )} .$$

Here, the adversary may satisfy the mean constraint by selecting K properly. Using Eq. (3), K* may be obtained as follows:

$${K}^{*} = \frac{2 {( e - 2 )}^{2} + ( 2 e - 5 )}{e - 2} B - 2 ( 2 e - 5 ) \frac{{B}^{2}}{μ} .$$

If K* is selected such that K*≧B, then

$$\frac{μ}{B} > 2 \frac{e - 2}{e - 1} .$$

It will be appreciated that this again becomes the case where the information about the mean does not benefit the designer. Hence, an interesting case to consider is when 0≦K*≦B, which translates to:

$$\frac{2 ( 2 e - 5 ) ( e - 2 )}{{e ( e - 2 )}^{2} + ( 2 e - 5 )} \leq \frac{μ}{B} \leq 2 \frac{e - 2}{e - 1} .$$

Thus, the optimal strategy of the adversary when

$$\frac{μ}{B} \leq 2 \frac{e - 2}{e - 1}$$

is:

$${q}^{*} ( y ) = \{ \begin{matrix}\frac{2 B ( e - 2 ) - μ}{2 {B}^{3} ( e - 2 ) ( 1 - \frac{2}{e} )} y {e}^{\frac{y}{B}} , & 0 \leq y < B , \\ \frac{μ}{2 B ( e - 2 ) ,} & y = {K}^{*} , \\ 0 , & otherwise .\end{matrix} \qquad Eq . ( 23 )$$

Otherwise, the optimal strategy of the adversary when

$$\frac{μ}{B} > 2 \frac{e - 2}{e - 1} .$$

is:

$${q}^{*} ( y ) = \{ \begin{matrix}\frac{y}{{B}^{2} ( e - 1 )} {e}^{1 - \frac{y}{B} ,} , & 0 \leq y < B , \\ \frac{1}{e - 1} , & y = {K}^{*} , \\ 0 , & otherwise .\end{matrix}$$

The following theorem amalgamates the analysis provided above: when imposing a constraint on the first (or second) moment of the strategy of the adversary, the optimal worst-case expected CR that can be achieved is

$$1 + \frac{μ}{2 B ( e - 2 )} ( or 1 + \frac{σ}{3 {B}^{2} ( 2 e - 5 )} ) ,$$

$$0 \leq μ \leq 2 \frac{e - 2}{e - 1} B ( or 0 \leq σ \leq 3 \frac{2 e - 5}{e - 1} {B}^{2} ) .$$

In both cases, the achieved CR outperforms that of the DET process 122_{D} and the PROB process 122_{P}.

The proof of the Theorem follows from Von Neumann's minimax theorem. The performance of the designer based on derivation of the optimal strategy of the designer under two difference conditions is shown in Eq. (15) and Eq. (18). Further, the optimal strategy of the adversary given in Eq. (23) has been derived under the first moment constraint which achieves Eq. (15). Therefore, it may be concluded based on Eq. (5) that the derived optimal strategies for the constrained ski-rental problem (namely, the μ-PROB process 122_{μ} and the σ-PROB process 122_{σ}) will yield the best worst-case CR and, further, Lemmas 1 and 2 show that the obtained expected CR for the derived optimal strategies for the constrained ski-rental problem outperform the expected CR for the DET process 122_{D} and the PROB process 122_{P}.

In general, the Theorem indicates that use of the constrained ski-rental problem guarantees the best possible worst-case expected CR. However, by Eq. (20), it may be concluded that when the arrival distribution is not selected optimally, a lower bound on the worst-case expected CR is obtained. This phenomenon has been simulated using three distributions: uniform, exponential, and log-normal.

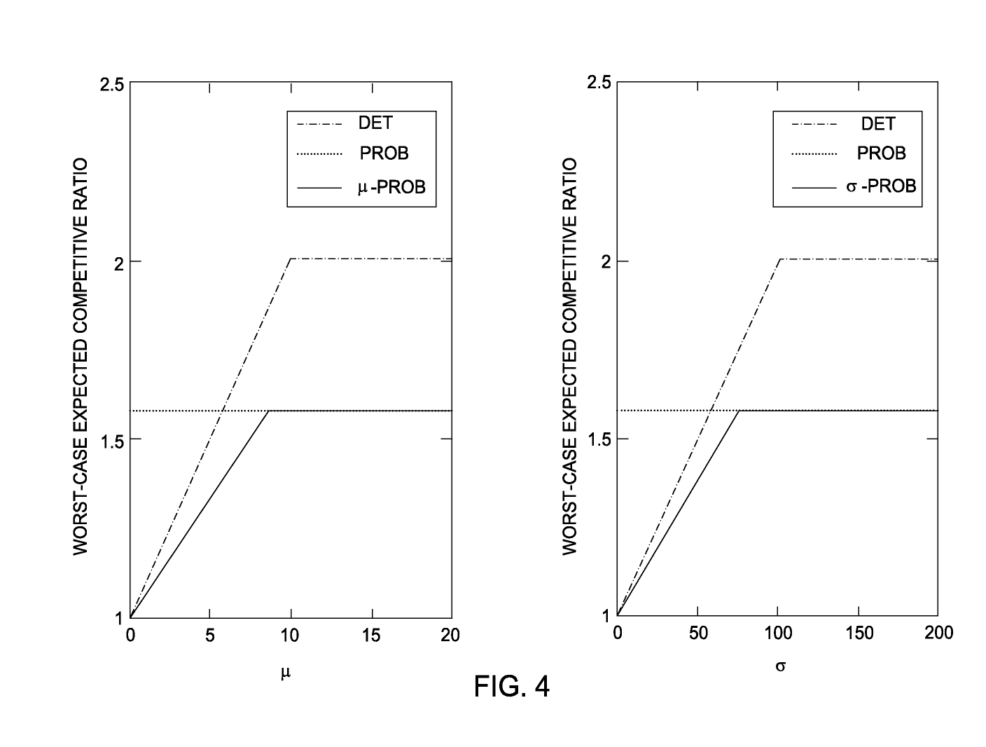

FIG. 4 depicts exemplary worst-case expected CR performances for the DET, PROB, μ-PROB, and σ-PROB processes. More specifically, FIG. 4 depicts exemplary worst-case expected CR performances for the DET process 122_{D}, the PROB process 122_{P}, the μ-PROB process 122_{μ}, and the σ-PROB process 122_{σ} for an exemplary embodiment in which B=10. As depicted in FIG. 4, the μ-PROB process 122_{μ}, and the σ-PROB process 122_{σ} exhibit similar CR performance. Accordingly, simulations are provided only for the μ-PROB process 122_{μ}, whereas simulations for the σ-PROB process 122_{σ} are omitted.

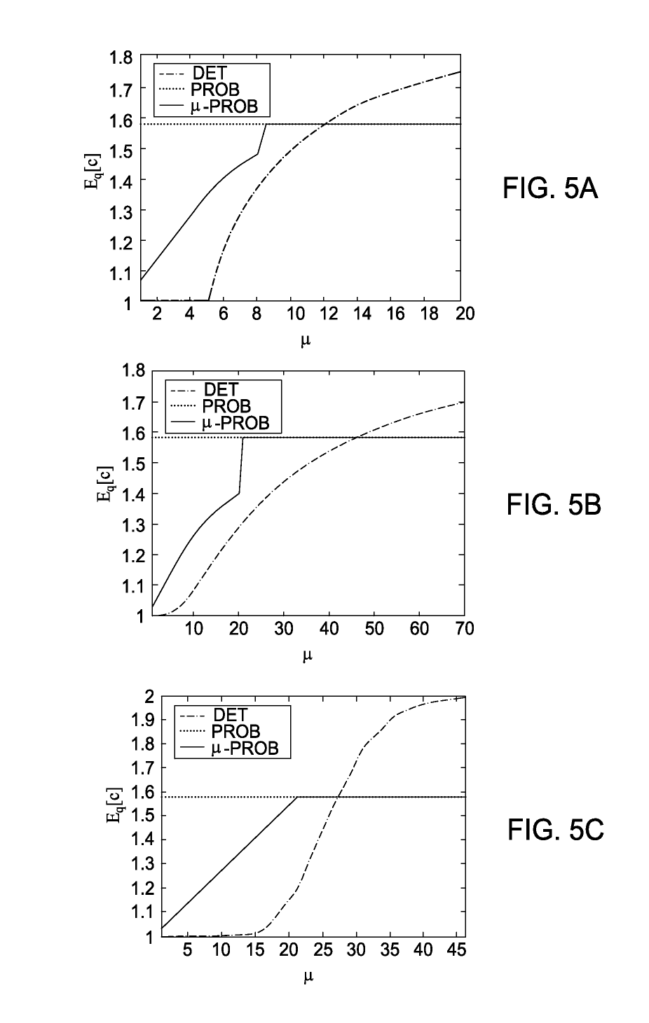

FIGS. 5A, 5B, and 5C depict exemplary expected CR performances for the μ-PROB process using uniform, exponential, and log-normal distributions.

FIG. 5A depicts expected CR performance for the μ-PROB process 122_{μ} for different values of μ when the arrivals are uniformly distributed over [0,2μ] and B=10. The DET process 122_{D} exhibits optimal performance for 2μ≦B, because the arrival distribution in this case falls entirely in the interval where the CR of the DET process 122_{D} is 1. However, as the value of μ increases, the CR of the DET process 122_{D} becomes 2 and, thus, the μ-PROB process 122_{μ} eventually outperforms the DET process 122_{D}. Further, the μ-PROB process 122_{μ} outperforms the PROB process 122_{P} for small values of μ.

FIG. 5B depicts expected CR performance for the μ-PROB process 122_{μ} for an exponential arrival distribution with parameter

$$\frac{1}{μ}$$

and B=25. The μ-PROB process 122_{μ} outperforms the PROB process 122_{P} for small values of μ; however, the DET process 122_{D} outperforms the μ-PROB process 122_{P} for small values of μ. This is primarily due to the fact that the exponential distribution places most of its weight on the interval [0,B] over which the DET process 122_{D} has a CR of 1. However, as μ increases, the exponential distribution places more weight outside [0,B] and the performance of the DET process 122_{D} worsens.

FIG. 5C depicts expected CR performance for the μ-PROB process for a log-normal arrival distribution with a standard deviation of 0.05. The μ-PROB process 122_{μ} outperforms the DET process 122_{D} as the value of μincreases.

It will be appreciated, at least from FIGS. 5A, 5B, and 5C as well as the foregoing analysis upon which FIGS. 5A, 5B, and 5C are based, that the μ-PROB process 122_{μ} exhibits an intermediate performance between the DET process 122_{D} and the PROB process 122_{P}. Namely, the μ-PROB process 122_{μ} outperforms the PROB process 122_{P} for small values of μ and outperforms the DET process 122_{D} for large values of μ.

It will be appreciated, at least from FIGS. 5A, 5B, and 5C as well as the foregoing analysis upon which FIGS. 5A, 5B, and 5C are based (although, as noted above, the associated simulations have been omitted), that the σ-PROB process 122_{σ} also exhibits an intermediate performance between the DET process 122_{D} and the PROB process 122_{P}. Namely, the σ-PROB process 122_{σ} outperforms the PROB process 122_{P} for small values of σ and outperforms the DET process 122_{D} for large values of σ.

In at least some embodiments, one or more of the processes 122 may be used independently of each other. For example, the DET process 122_{D} may be used to solve a ski-rental problem, the PROB process 122_{P} may be used to solve a ski-rental problem, the μ-PROB process 122_{μ} may be used to solve a ski-rental problem, the σ-PROB process 122_{σ} may be used to solve a ski-rental problem, or a process based on a higher order moment (e.g., third moment, fourth moment, or the like) may be used to solve the ski-rental problem.

In at least some embodiments, two or more of the processes 122 may be used such that an optimal process 122 is selected and used based on information indicative of the value(s) of the moment(s) for the associated process(es). For example, where the DET process 122_{D}, the PROB process 122_{P}, and μ-PROB process 122_{μ} are available for use in solving a ski-rental problem, the value of the first moment μ may be computed and used to determine which of the three processes is to be used to solve the ski-rental problem. For example, where the DET process 122_{D}, the PROB process 122_{P}, and σ-PROB process 122_{σ} are available for use in solving a ski-rental problem, the value of the second moment a may be computed and used to determine which of the three processes is to be used to solve the ski-rental problem. For example, where the DET process 122_{D}, the PROB process 122_{P}, the μ-PROB process 122_{μ}, and the σ-PROB process 122_{σ} are available for use in solving a ski-rental problem, the values of the first moment μ and the second moment a may be computed and used to determine which of the four processes is to be used to solve the ski-rental problem. The use of other combinations of processes 122 to solve a ski-rental problem is contemplated. It will be appreciated that combined consideration and use of processes 122 providing solutions to the classical ski-rental problem (e.g., the DET process 122_{D}, the PROB process 122_{P}, or the like) and processes 122 providing solutions to the constrained ski-rental problem (e.g., the μ-PROB process 122_{μ}, the σ-PROB process 122_{σ}, one or more processes related to higher moments, or the like) exhibits robust average-cost performance that combines the best performance characteristics of the various types of ski-rental processes.

It will be appreciated that, from a worst-case CR perspective, the PROB process 122_{P} typically is preferable to the DET process 122_{D}; however, it is possible to improve the worst-case CR performance of the PROB process 122_{P} given additional information indicative of the distribution of arrivals of events related to the decision for which the ski-rental problem is applied. It will be appreciated that at least some embodiments of the constrained ski-rental problem provide improvements over the DET process 122_{D} and the PROB process 122_{P}. It will be appreciated that at least some embodiments of the constrained ski-rental problem provide worst-case performance guarantees independent of the distribution of the arrivals of events related to the decision for which the ski-rental problem is applied. It will be appreciated that at least some embodiments of the constrained ski-rental problem give rise to distributions that outperform both the DET process 122_{D} and the PROB process 122_{P}. It will be appreciated that at least some embodiments of the constrained ski-rental problem enable the algorithm designer to exploit knowledge of one or more moments of the strategy of the adversary to provide cost optimization associated with a decision between two actions having two costs associated therewith, thereby leading to a new class of randomized processes that provide arrivals-distribution-free performance guarantees and improvements in worst-case CR performance as compared with unconstrained ski-rental problems. It will be appreciated that at least some embodiments of the constrained ski-rental problem may be formulated as a continuous-kernel zero-sum game between the process designer who seeks to minimize the expected CR and an adversary attempting to maximize the expected CR. It will be appreciated that, in at least some embodiments, mixed-strategies may be derived for both the designer and the adversary in closed form.

As described herein, the constrained ski-rental problem defined herein may be used for various applications (e.g., to determine whether to rent or buy a product or service, determine whether to store a data block in disk or in cache, determine how to handle storage of data in a computer having multiple types of storage modules, determine how to handle query requests for a given query in a cloud-based system, or the like). More detailed descriptions of use of the constrained ski-rental problem for at least some such applications follow.

In at least some embodiments, the constrained ski-rental problem may be used to determine whether to store a data block in disk or in cache.

In general, cloud service providers (CSPs) rent cloud resources (e.g., CPU, memory, storage, or the like) at various price points and offer tenants the ability to elastically scale the resources depending on the demand. Since many services have been virtualized, it is often possible for a customer (e.g., enterprise, individual user, or the like) to scale the amount of resources needed to satisfy the current demand for a service by scaling the number of virtual machines (VMs) supporting that service. However, it will be appreciated that scaling the number of VMs is not the only way to reduce costs for a cloud-based service.

For example, for a web application running in the cloud, the web application has the following two options each time a given query is received by the web application: (1) recompute the result of the query (which involves CPU costs and I/O costs, if any, for using the disk) or (2) compute the result of the query in response to the first query and store the result of the query in cache such that the result of the query may be sourced from the cache for each subsequent query having the same parameters (which incurs the storage cost of the cache while saving the CPU and I/O costs for each subsequent query having the same parameters). In this example, choosing the more economic option for the web application depends on the relative costs of CPU, I/O, and cache storage of the CSP, and the frequency with which the queries are received at the web application.

Similarly, for example, for a file system running in the cloud, the file system has the following two options each time a request for a given data block is received by the file system: (1) read the data block from the disk and return the data block to the requesting entity (which incurs a disk I/O cost) or (2) store the data block in cache in response to the first request for the data block and source the data block from the cache rather than from the disk in response to subsequent requests for the data block (which incurs I/O and storage costs of the cache which saving the I/O cost of the disk which is typically more expensive than the I/O cost of the cache).

From the foregoing examples, it will be appreciated that there are various cost-based decisions that need to be made in the cloud even when the traffic is not varying considerably. This problem becomes more complex when the costs of different options vary widely. For example, consider an exemplary pricing model for three cloud services as depicted in Table 3.

TABLE 3

| | Storage | | |
|---|---|---|---|
| Service Name | ($/GB/month) | Read | Write |
| Service 1 (CSP1, | 38 | 0 | 0 |
| Cache) | | | |
| Service 2 (CSP1, | 0.110 | 1 × 10⁻⁶ | 10 × 10⁻⁶ |
| Disk) | | | |
| Service 3 (CSP2, | 0.125 | 1 × 10⁻⁶ | 1 × 10⁻⁶ |
| Disk) | | | |

For example, based on the pricing model of Table 3, a customer could choose to store an object using Service 1 or Service 2, where (1) Service 1 has a much higher storage cost than Service 2, but has free I/O and (2) Service 2 which has a much lower storage cost than Service 1, but has relatively high per I/O costs compared to Service 1. In this example, it is cheaper to use Service 1 when many requests for the same object arrive within a relatively short interval whereas it is cheaper to use Service 2 when requests for the same object are relatively far apart. This problem is further complicated by the fact that the costs of the various options often vary across CSPs (e.g., Service 2 and Service 3 in Table 3).

For example, based on the pricing model of Table 3, Service 3 has ten times lower write costs than Service 2, but only 10% higher storage costs than Service 2. Thus, there may be situations in which it is more cost effective to split a cloud-based service across multiple CSPs in order to further optimize the locations of the disk, the read operations, and the write operations.

As will be appreciated from the foregoing examples, given the per unit time cost of various cloud resources (and variations in such costs between services of CSPs and between CSPs), there are various situations in which costs can be improved or even optimized in the cloud by trading off one or more of compute vs. storage, disk vs. cache, bandwidth vs. cache, or the like.

In many cases, these decisions can be abstracted using a ski-rental problem, which, generally, represents a fundamental tradeoff between renting or buying a certain item (e.g., product, service, resource, or the like) when the period of usage is not known a priori to the person interested in the item. In a basic form of the ski-rental problem, the designer is faced with the option of either renting or buying skis from the adversary, but the designer does not know the number of days he or she will be skiing and is interested in minimizing the overall cost of the ski trip. This basic form of the ski-rental problem may be mapped to other scenarios to which the ski-rental problem may be applied. For example, in the compute versus storage decision scenario, the act of renting the skis may be mapped to recomputing the query response each time the query is receive, the act of buying the skis can be mapped to storing the query result in the cache, and the unknown number of ski days may be mapped to the fact that we do not know how many times and how frequently a query will be requested. Similarly, for example, in the disk versus cache decision scenario, the act of renting the skis may be mapped to retrieving the data block from the disk each time the data block is requested, the act of buying the skis can be mapped to storing the data block in the cache, and the unknown number of ski days may be mapped to the fact that we do not know how many times and how frequently the data block will be requested. The ski-rental problem abstracts such scenarios where a skier is faced with a to-rent-or-to-buy decision and, thus, may be used where a customer of a cloud service provider is faced with a cloud-related decision (e.g., compute versus cache, disk versus cache, or the like).

The use of moment information in a cloud-based file system may be better understood with respect to the following example. In this example, a file system in running in the cloud of a CSP where the CSP supports two types of storage resources as follows: a disk and a cache. The disk I/O is more expensive than the cache I/O, while the cache storage cost is more expensive than the disk storage cost. As an example, let B=10 (this value is merely exemplary, as any suitable value may be used) to indicate that the disk I/O per data block is ten times more expensive than storing the data block for one unit of time (e.g., a second). In this exemplary file system, the requests to the file system arrive at various points in time, and a server that receives and handles the requests chooses between storing the response in the cache and fetching it fresh from the disk based on the DET process 122_{D}, the PROB process 122_{P}, or the μ-PROB process 122_{μ}. It is noted that, while the analysis of the constrained ski-rental problem primarily focused on the CRs of the various processes 122, the evaluation for the exemplary file system focuses on the total cost.

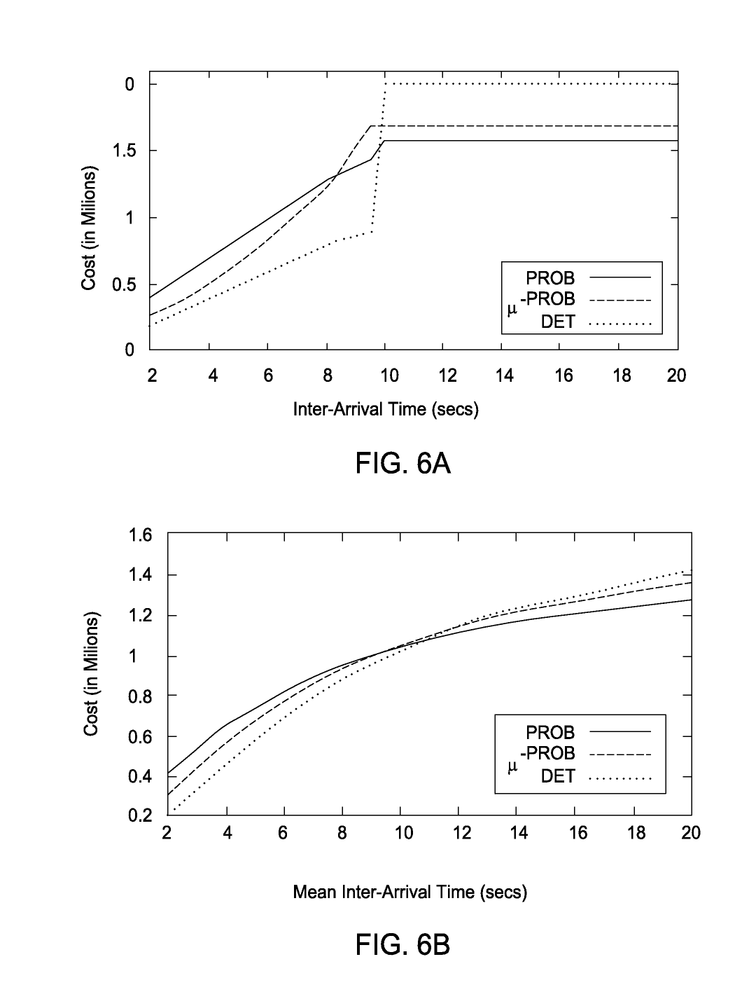

FIGS. 6A and 6B depict exemplary cost performances for the DET, PROB, and μ-PROB processes using fixed and exponential arrival distributions in an exemplary cloud-based file system. In FIG. 6A, fixed inter-arrival times are used, and the cost of running the exemplary file system on the cloud for different arrival values is measured. In FIG. 6B, exponentially distributed inter-arrival times are used, and the average cost of running the exemplary file system on the cloud for different mean arrival values is measured. FIG. 6A and FIG. 6B illustrate that the DET process 122_{D} is the optimal process for arrivals occurring before time B, while the PROB process 122_{P} is the optimal process for arrivals occurring after time B. FIG. 6A and FIG. 6B further illustrate that the μ-PROB process 122_{μ} is quite robust as it approximates the best portions of the DET process 122_{D} and the PROB process 122_{P} for different inter-arrival values.

In other words, the constrained ski-rental problem may be used to determine whether to store a data block in disk or in cache. The two options for storage of the data block have two different costs associated therewith. The constrained ski-rental problem may be used to determine whether to store a data block in disk or in cache based on inter-arrival time information associated with arrivals related to the data block (e.g., the first moment of the inter-arrival times between arrivals related to the data block as specified by the μ-PROB process 122_{μ}, the second moment of the inter-arrival times between arrivals related to the data block as specified by the σ-PROB process 122_{σ}, or the like). In at least some embodiments, various combinations of two or more of the DET process 122_{D}, the PROB process 122_{P}, the μ-PROB process 122_{μ}, and the σ-PROB process 122_{σ} may be used to determine whether to store a data block in disk or in cache.

In at least some embodiments, the constrained ski-rental problem may be used to determine a length of time for which a data block is to be stored in cache before being evicted from the cache such that the data block is stored only in the disk. In at least some embodiments, when a data block that is stored in a disk is stored in an associated cache or accessed from the associated cache, a data block eviction time (or timeout value indicative of a data block eviction time) is computed and the data block is evicted from the cache if the data block eviction time is reached without a subsequent access to the data block. The determination of the data block eviction time may be performed using a deterministic scheme (e.g., each time the data block is accessed, updating the data block eviction time to be [[time of access to data block]+[threshold time associated with data block]]) or a probabilistic scheme (e.g., computing a threshold for the data block, generating a random variable which is a uniformly distributed random variable in the range [0:1], and computing the data block eviction time based on the threshold and the random variable (e.g., as [threshold [log[(e−1) (random variable)+1]])). In at least some embodiments, the constrained ski-rental problem may be used to determine a length of time for which a data block is to be stored in cache before being evicted from the cache by using the first moment of inter-arrival times to set the data block eviction time for the data block. In at least some embodiments, the constrained ski-rental problem may be used to determine a length of time for which a data block is to be stored in cache before being evicted from the cache by using the first moment of inter-arrival times to generate a random number which is distributed in the range [0:B] and using the random number as the timeout value or to compute the timeout value.

In at least some embodiments, the constrained ski-rental problem may be used to determine how to handle query requests for a given query in a cloud-based system, namely, whether to recompute the query result each time that the query is received or whether to store the query result the first time that the query request is received and then serve each subsequent query request using the stored value. The two options for handling of the query requests have two different costs associated therewith. The constrained ski-rental problem may be used to determine how to handle the query requests based on inter-arrival time information associated with arrivals of the query requests (e.g., the first moment of the inter-arrival times between arrivals of the query requests as specified by the μ-PROB process 122_{μ}, the second moment of the inter-arrival times between arrivals of the query requests as specified by the σ-PROB process 122_{σ}, or the like). In at least some embodiments, various combinations of two or more of the DET process 122_{D}, the PROB process 122_{P}, the μ-PROB process 122_{μ}, and the σ-PROB process 122_{σ} may be used to determine how to handle query requests for a given query in a cloud-based system.

In at least some embodiments, the constrained ski-rental problem may be used to determine how to handle storage of data in a computer having multiple types of storage modules (e.g., hard disk and RAM). In at least some such embodiments, the constrained ski-rental problem may be used to optimize energy consumption (which also may be thought of as energy cost) of the different types of storage modules in the computer when storing data. The constrained ski-rental problem may be used to determine how to handle storage of data in a computer having multiple types of storage modules based on inter-arrival time information associated with arrivals of the requests to store or retrieve data (e.g., the first moment of the inter-arrival times between arrivals of requests to store or retrieve data as specified by the μ-PROB process 122_{μ}, the second moment of the inter-arrival times between arrivals of requests to store or retrieve data as specified by the σ-PROB process 122_{σ}, or the like). In at least some embodiments, various combinations of two or more of the DET process 122_{D}, the PROB process 122_{P}, the μ-PROB process 122_{μ}, and the σ-PROB process 122_{σ} may be used to determine how to handle storage of data in a computer having multiple types of storage modules.

In at least some embodiments, the constrained ski-rental problem may be used to determine whether to rent or buy a product or service. The actions of renting or buying having rental and purchasing costs associated therewith, respectively. The constrained ski-rental problem may be used to determine whether to rent or buy a product based on inter-arrival time information associated with arrivals of events related to the determination as to whether to rent or buy the product or service (e.g., the first moment of the inter-arrival times between arrivals of events related to the determination as to whether to rent or buy the product or service as specified by the μ-PROB process 122_{μ}, the second moment of the inter-arrival times between arrivals of events related to the determination as to whether to rent or buy the product or service as specified by the σ-PROB process 122_{σ}, or the like). In at least some embodiments, various combinations of two or more of the DET process 122_{D}, the PROB process 122_{P}, the μ-PROB process 122_{μ}, and the σ-PROB process 122_{σ} may be used to determine whether to rent or buy a product or service.

In view of the various potential applications of the constrained ski-rental problem, as specifically discussed hereinabove and as will be appreciated in view of the exemplary applications discussed above, it will be appreciated that the constrained ski-rental problem may be expressed more generally as a determination as to whether to perform a first action having a first cost associated therewith or to perform a second action having a second cost associated therewith based on moment information associated with inter-arrival times between events related to the first and second actions (e.g., at least one moment of inter-arrivals, such as one or more of a first moment of inter-arrival times, a second moment of inter-arrival times, a third moment or inter-arrival times, or the like, as well as various combinations thereof). For example, for embodiments in which the constrained ski-rental problem is used to determine whether to rent or buy a product or service, the first action may be the act of renting the product or service (which has a rental cost associated therewith), the second action may be the act of buying the product or service (which has a purchasing cost associated therewith), the events may be days on which the product or service may be used or is expected to be used (e.g., snowy days where the product is skis, days on which a particular software program may be used or is expected to be used where the product is a software program, or the like), and the inter-arrival time may be the inter-arrival time between the days on which the product or service may be used or is expected to be used. Similarly, for example, for embodiments in which the constrained ski-rental problem is used to determine how to handle storage of data in a computer having multiple types of storage modules, the first action may be the act of storing the data in the disk (which has a first energy cost associated therewith), the second action may be the act of storing the data in the RAM (which has a second energy cost associated therewith), the events may be arrivals of requests to store data, and the inter-arrival time may be the inter-arrival time between the arrivals of the requests to store data. Similarly, for example, for embodiments in which the constrained ski-rental problem is used to determine how to handle query requests for a given query in a cloud-based system, the first action may be the act of recomputing the query result in response to each query request (which has a first cost associated therewith), the second action may be the act of storing the query result in cache and sourcing the query result from the cache in response to each query request (which has a second cost associated therewith), the events may be arrivals of query requests, and the inter-arrival time may be the inter-arrival time between the arrivals of the query requests. It will be appreciated that other applications of the constrained ski-rental problem may be similarly mapped to the general expression of the constrained ski-rental problem. It will be appreciated that various other cost optimization problems may be abstracted as a ski-rental problem.

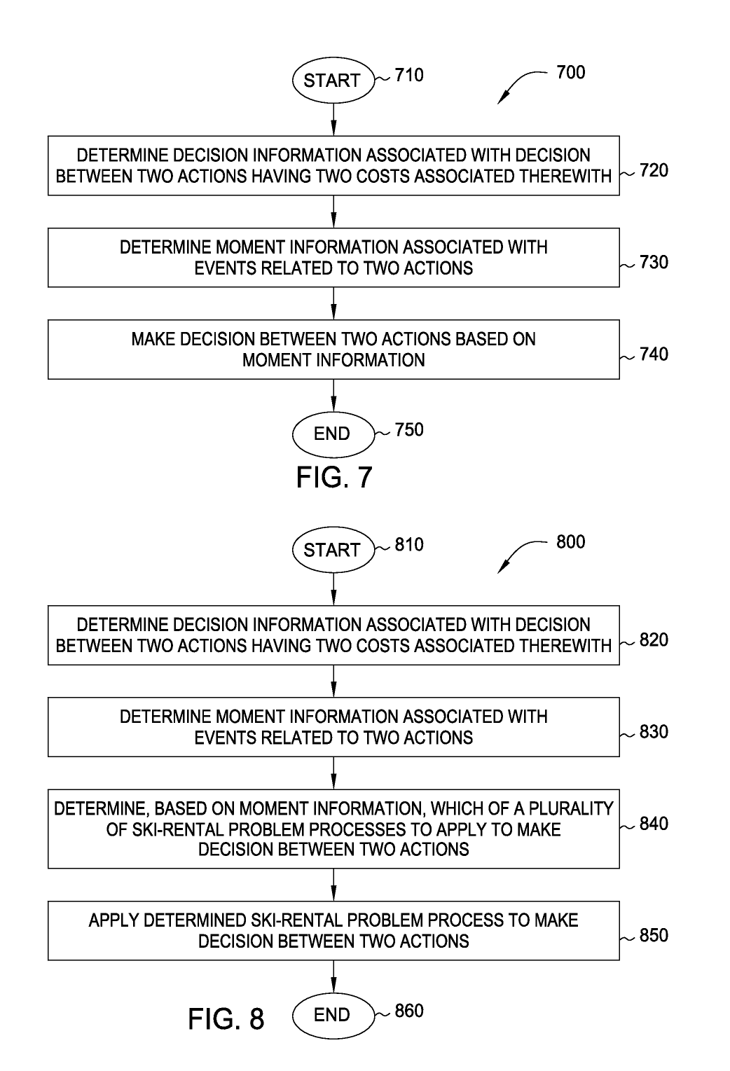

FIG. 7 depicts one embodiment of a method for using a constrained ski-rental problem to perform a decision between two actions having two costs associated therewith.

At step 710, method 700 begins.

At step 720, decision information associated with a decision is determined. The decision is a decision between two actions having two costs associated therewith, respectively.

At step 730, moment information associated with events related to the two actions is determined. The moment information may include a moment of a number of events associated with the first action and the second action, a moment of inter-event times between occurrences of events associated with the first action and the second action, or the like. The inter-event times between occurrences of events may include inter-use times between expected uses of a product or service, inter-arrival times between arrivals of requests for information, or the like. The moment information may include a first moment, a second moment, or the like.

The moment information may be updated as each event occurs (e.g., updating the average number of occurrences as each event occurs, updating a variance of the number of occurrences as each event occurs, updating average inter-event occurrence time as each event occurs, updating the variance of the inter-event occurrence time as each event occurs, or the like) and accessed for use in making the decision. The moment information may be computed based on historical data regarding event arrivals (e.g., recorded as each event occurs).

At step 740, the decision is made based on the moment information associated with events related to the two actions.

At step 750, method 700 ends.

It will be appreciated that, although depicted and described as ending, the decision may be handled in any suitable manner (e.g., stored, transmitted, used as an input to another process to be executed, or the like, as well as various combinations thereof). It will be further appreciated that the manner in which the decision is used may be dependent upon the application with which the decision is associated.

FIG. 8 depicts one embodiment of a method for determining which of a plurality of ski-rental problems to apply when performing a decision between two actions having two costs associated therewith.

At step 810, method 800 begins.

At step 820, decision information associated with a decision is determined. The decision is a decision between two actions having two costs associated therewith, respectively.

At step 830, moment information associated with events related to the two actions is determined. The moment information may include a moment of a number of events associated with the first action and the second action, a moment of inter-event times between occurrences of events associated with the first action and the second action, or the like. The inter-event times between occurrences of events may include inter-use times between expected uses of a product or service, inter-arrival times between arrivals of requests for information, or the like. The moment information may include a first moment, a second moment, or the like.

At step 840, a determination is made as to which of a plurality of ski-rental problems to apply to perform the decision between the first action and the second action.

At step 850, the determined ski-rental problem is applied to perform the decision between the first action and the second action.

At step 860, method 800 ends.

It will be appreciated that, although primarily depicted and described with respect to use of specific moments (namely, the first moment and the second moment) to improve cost when the constrained ski-rental problem is used, any suitable moment or moments (e.g., one or more higher moments, such as the third moment, fourth moment, or the like) may be used to improve cost when the constrained ski-rental problem is used. It will be appreciated that, in at least some embodiments, use of higher order moment information (e.g., beyond the first moment and the second moment) may provide further improvements in cost optimization.

It will be appreciated that, although primarily depicted and described herein with respect to use of the constrained ski-rental problem for specific applications, the constrained ski-rental problem may be used in any other suitable applications in which an entity is confronted with a decision which may impact cost incurred by the entity.

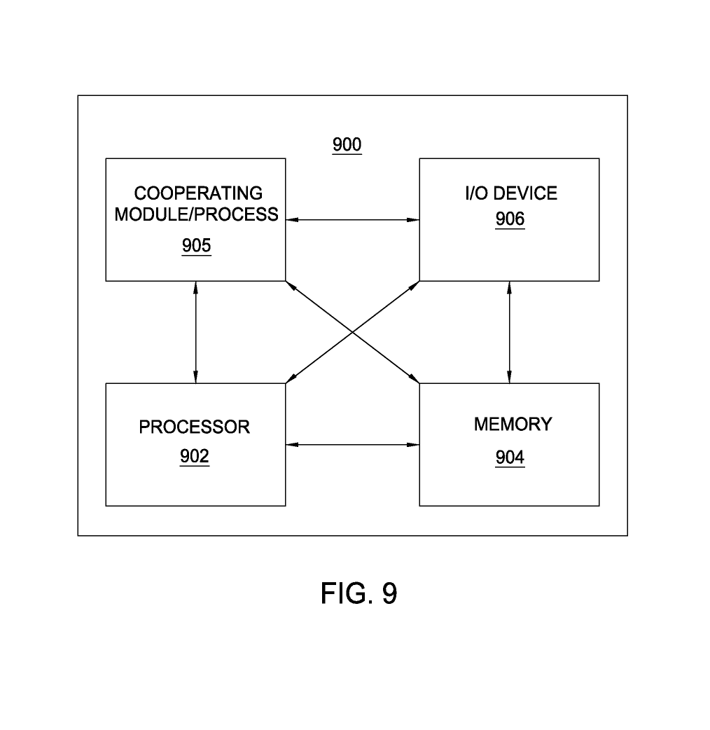

FIG. 9 depicts a high-level block diagram of a computer suitable for use in performing functions described herein.

The computer 900 includes a processor 902 (e.g., a central processing unit (CPU) or other suitable processor(s)) and a memory 904 (e.g., random access memory (RAM), read only memory (ROM), and the like).

The computer 900 also may include a cooperating module/process 905. The cooperating process 905 can be loaded into memory 904 and executed by the processor 902 to implement functions as discussed herein and, thus, cooperating process 905 (including associated data structures) can be stored on a computer readable storage medium, e.g., RAM memory, magnetic or optical drive or diskette, and the like.

The computer 900 also may include one or more input/output devices 906 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 900 depicted in FIG. 9 provides a general architecture and functionality suitable for implementing functional elements described herein or portions of functional elements described herein. For example, the computer 900 provides a general architecture and functionality suitable for implementing one or more computer 100, a portion of computer 100, or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or,” unless otherwise indicated (e.g., “or else” or “or in the alternative”).

It will be appreciated that, while the foregoing is directed to various embodiments of features present herein, other and further embodiments may be devised without departing from the basic scope thereof.

What is claimed is:

1. An apparatus, comprising:
a processor and a memory communicatively connected to the processor, the processor configured to:
determine whether a first action having a first cost associated therewith or a second action having a second cost associated therewith is more cost effective based on moment information for events associated with the first action and the second action.

2. The apparatus of claim 1, wherein the moment information comprises a moment of a number of events associated with the first action and the second action or a moment of inter-event times between occurrences of events associated with the first action and the second action.

3. The apparatus of claim 2, wherein the inter-event times between occurrences of events comprise inter-use times between expected uses of a product or service or inter-arrival times between arrivals of requests for information.

4. The apparatus of claim 1, wherein the moment information comprises a first moment or a second moment.

5. The apparatus of claim 1, wherein the moment information comprises a moment value computed based on the first cost associated with the first action and the second cost associated with the second action.

6. The apparatus of claim 1, wherein the processor is configured to determine whether a first action or a second action is more cost effective by:
selecting, based on the moment information, one of a plurality of ski-rental processes configured for determining whether the first action or the second action is more cost effective; and
determining whether the first action or the second action is more cost effective based on selected one of the ski-rental processes.

7. The apparatus of claim 6, wherein the plurality of ski-rental processes comprises at least two of a deterministic ski-rental process, a probabilistic ski-rental process, a first-moment-constrained ski-rental process, or a second-moment-constrained ski-rental process.

8. The apparatus of claim 6, wherein the moment of inter-arrival times between events associated with the first action and the second action comprises a first moment μ, wherein selecting the one of the plurality of ski-rental processes based on the first moment μ is based on a determination as to whether the first moment μ is less than or greater than
$$2 \frac{e - 2}{e - 1} B ,$$
wherein B comprises a value based on the first cost and the second cost.

9. The apparatus of claim 8, wherein a first-moment-constrained ski-rental process is selected based on a determination that the first moment μ is less than
$$2 \frac{e - 2}{e - 1} B .$$

10. The apparatus of claim 8, wherein a probabilistic ski-rental process or a deterministic ski-rental process is selected based on a determination that the first moment μ is greater than
$$2 \frac{e - 2}{e - 1} B .$$

11. The apparatus of claim 6, wherein the moment information comprises a second moment σ, wherein selecting the one of the plurality of ski-rental processes based on the second moment σ is based on a determination as to whether the second moment σ is less than or greater than
$$3 \frac{2 e - 5}{e - 1} {B}^{2} ,$$
wherein B comprises a value based on the first cost and the second cost.

12. The apparatus of claim 11, wherein a second-moment-constrained ski-rental process is selected based on a determination that the second moment σ is less than
$$3 \frac{2 e - 5}{e - 1} {B}^{2} .$$

13. The apparatus of claim 11, wherein a probabilistic ski-rental process or a deterministic ski-rental process is selected based on a determination that the second moment σ is greater than
$$3 \frac{2 e - 5}{e - 1} {B}^{2} .$$

14. The apparatus of claim 1, wherein the first action comprises renting an item and the second action comprises buying an item, wherein the events comprise uses of the item or opportunities for using the item.

15. The apparatus of claim 1, wherein the first action comprises storing a data block in a disk and the second action comprises storing a data block in a cache, wherein the events comprise requests associated with the data block.

16. The apparatus of claim 15, wherein the processor is configured to:
determine, based on a determination to store the data block in cache, information indicative of a length of time for which the data block is to be stored in cache before being evicted from the cache, wherein the information is determined based on a value determined based on the first cost associated with the first action and the second cost associated with the second action.

17. The apparatus of claim 1, wherein the first action and the second action are associated with a query, wherein the first action comprises recomputing a query result each time a request for the query is received, wherein the second action comprises storing a query result for the query and serving the query result from storage each time a request for the query is received, wherein the events comprise the requests for the query.

18. The apparatus of claim 1, wherein the first action and the second action are associated with storage of data in a computing device having a plurality of storage module types, wherein the first action comprises storing the data in a first storage module of a first storage module type and the second action comprises storing the data in a second storage module of a second storage module type, wherein the events comprise requests to store the data.

19. The apparatus of claim 1, wherein the processor is configured to:
initiate execution of the first action or the second action based on the determination as to whether the first action or the second action is more cost effective.

20. A computer-readable storage medium storing instructions which, when executed by a computer, cause the computer to perform a method, the method comprising:
determining whether a first action having a first cost associated therewith or a second action having a second cost associated therewith is more cost effective based on moment information of events associated with the first action and the second action.

21. A method, comprising:
using a processor for:
determining whether a first action having a first cost associated therewith or a second action having a second cost associated therewith is more cost effective based on moment information of events associated with the first action and the second action.
